(19) United States
(12) Patent Application Publication
(10) Pub. No.: US 2016/0379182 A1
(43) Pub. Date: Dec. 29, 2016

(54) Methods for Providing an Online Consumer Network

(71) Applicant: FMR LLC, Boston, MA (US)

(72) Inventors: Xinxin Sheng, Cary, NC (US); Hong Sun, Cary, NC (US); Chad Iverson, Boston, MA (US)

(21) Appl. No.: 14/753,838

(22) Filed: Jun. 29, 2015

(51) Int. Cl. G06Q 20/02; G06Q 20/40

(52) U.S. Cl. CPC G06Q 20/027; G06Q 20/4016

(57) ABSTRACT

Methods for providing a consumer services network are provided. For each electronic transaction that occurs between members of the network, a public and private trust rating score are determined based on the outcome and quality of electronic transactions.

### FIELD OF THE INVENTION

The invention relates generally to computer-based methods and frameworks for providing an online consumer network. More specifically, a trust rating score between nodes of the consumer network is determined based on electronic transactions between two or more nodes.

### BACKGROUND

Consumers perform online electronic transactions to perform many tasks. For example, consumers may need to get a mortgage, pass employee background checks, user tax services and/or consult with their financial advisor. In each of these exemplary online electronic transactions, consumers may need to select an institution to purchase services from and/or provide personal information. Currently, online consumer networks can help consumers gain confidence that institutions they select for their online electronic transactions are secure, honest and reputable based on ratings provided by other consumers, service provider reviews and/or through expert reviews. However, consumer ratings can be deficient in several ways.

One deficiency of current methods for consumer ratings is that they are limited to consumers willing to participate. Thus, they do not account for the success or failure of many transactions of members of the consumer network that are not willing to fill out online surveys. One difficulty with expert ratings is that they represent only a single point of view and are typically not equally available, credible, and/or current across categories of consumer services. One difficulty with service provider ratings is that they can be biased due to selective publishing.

Another difficulty with current methods for consumer rating is that consumer ratings input by consumers offer consumers no protections from fraud. For example, even if a particular institution has high ratings, a single employee within that institution can be fraudulent and use the online transaction with the consumer to obtain personal information to commit fraud with. In many instances, in order to gain enough information to commit fraud, the single employee asks the consumer for information that is beyond what is needed to complete the particular online transaction the consumer is requesting, thus exposing the consumer to sharing too much information and fraud.

Another deficiency of current methods for consumer ratings is that current ratings are open to any resource, such as better business bureau, or any user views system used by online stores, allowing any person to be allowed to put a score on a service/product. Another deficiency of current methods is that computer programs apps can rate services/products, contributing to erroneous ratings.

Consumer ratings input by consumers offer no way for an institution to gain information regarding the consumer (e.g., level confidence regarding the legitimacy and reliability of the consumer, rating the consumer gives the institution, etc.) Thus, it is desirable to provide an online consumer network that determines the trustworthiness of all members, both consumers and institutions.

It is also desirable to provide ratings between members of the network that are based on electronic transactions between the members instead of rating that are based solely on input of consumers. It is also desirable to provide an online consumer network that allows institutions to gain information regarding the consumer. It is also desirable for a consumer to have confidence that the information being requested by an institution is actually needed to complete the consumer's online transaction.

### SUMMARY OF THE INVENTION

One advantage of the invention is that it allows for more accurate scoring of members of an online consumer network because the ratings are determined based on quality of electronic transactions between the members. Another advantage of the invention is that it allows institution members to view ratings of consumers of the online consumer network. Another advantage of the invention it that is allows for assessment of trust as transactions are happening in the system, rather than an off-line analysis that likely includes stale information regarding the members and their interactions.

Another advantage of the invention is that it allows for ratings to accumulate without the input of a consumer. Another advantage of the invention is that it allows transitive rating scores, such that a first user can deduce rating scores based on a trust level between a second user and an institution, and the trust level between the first user and the second user. Another advantage of the invention is that it provides a robust rating score that can be based on public opinions, private opinions and/or historical factors.

Another advantage of the invention is that it allows a best path through the network to be determined to give the members the highest confidence that the transaction they propose to embark on will be a good one.

Another advantage of the invention is that it provides a reverse query ability to target nodes (e.g., institution). Target nodes can evaluate a source node (e.g., consumer) by for example, collecting the source nodes rating scores received from third parties. Another advantage of the invention is that target nodes can traverse through the network to see a source node's behavior on other target nodes and/or determine a source node's transaction patterns (e.g., a consumer is conservative and only does transactions with institutions that have very good ratings under related business domains).

Another advantage of the invention is that institutions can use trust rating scores to identify loyal and/or potentially loyal consumers relative to other consumers, even in the absence of a direct relationship. Initiations can also determine the likelihood that target consumers choose them over known competing service providers.

Another advantage of the invention is it provides consumer members of the online consumer network with confidence that their private information is actually required for the particular online transaction they seek to complete.

Another advantage of the invention is that it allows its members (e.g., consumers and service providers); to obtain a comprehensive view of trust levels for a range of directly and indirectly connected parties on a consumer network. The trust levels allow for participants to perform ranking in the consumer network based on historical transactions and received updated trust rating scores in real-time.

In one aspect, the invention involves a computer-implemented method of providing a consumer services network. The method involves creating a new entity node, by a computing device, for each electronic transaction performed by each member of the consumer network that includes a new entity. The method also involves determining, by the computing device, an expected transaction score for each electronic transaction, the expected transaction score based on a public trust rating score and a private trust rating score between at least one member of all members of the consumer services network involved in the particular electronic transaction for which the expected transaction score is determined. The method also involves determining, by the computing device, an updated public trust rating score and an updated private trust rating score once the transaction has occurred. The method also involves creating, by the computing device, a link for each transaction score between its respective members of the consumer services network, the link comprising the updated public trust rating score and updated private trust rating score and a direction of transaction that indicates a flow of information between the respective members.

In some embodiments, the method also involves receiving, by the computing device, a request for a confidence value determination between two members of the consumer services network, the request specifying a first member of the consumer services network and a second member of the consumer services network, and determining, by the computing device, the confidence value by determining a best path through the consumer services network between a first of the two members of the consumer services network to a second of the two members of the consumer services network, and transmitting, by the computing device, the confidence value to a display of the requestor.

In some embodiments, the invention involves receiving, by the computing device, a request for target nodes for a particular member of the consumer services network, determining, by the computing device, a preliminary target node list by adding any member of the consumer network that is subscribed to at least one service of the particular member but not all services of the particular member, and determining, by the computing device, the target nodes by including any member of the consumer network on the preliminary target node list that a) is subscribed to a service provided by the particular member via a service provider of the consumer network other than the particular member and a trust rating score between the member and the service provider is less than a trust rating score between the member and the particular member, or b) has a trust rating score between the member and the particular member is greater than a predetermined threshold.

In some embodiments, the private trust rating score is based on current and past quality of transaction between each member of the consumer services network.

In some embodiments, the public trust rating score is based on public transactions between each member of the consumer services network.

In some embodiments, the best path is based on each path's minimum trust rating score, path length, a role consistence in each path, or any combination thereof.

In some embodiments, the method also involves receiving, by the computing device, a request from a first member of the consumer services network for a determination as to whether a second member of the consumer services requires access to information the second member is requesting in relation to a service the second member is proving to the first member, determining, by the computing device, an expected trust rating score, the expected trust rating score is an estimate of the trust rating score after the electronic transaction between the first member and the second member is complete, and determining, by the computing device, whether the second member is authorized to receive the information from the first member based on the expected trust rating score.

In some embodiments, the second member is authorized to receive the information if the expected trust rating score is greater than a trust rating threshold. In some embodiments, the method involves filtering, by the computing device, the information if the second member is not authorized to receive the information from the first member. In some embodiments, the method involves alerting, by the computing device, the first member that the second member is likely a fraudulent user if the difference between the expected trust rating score and the trust rating threshold is greater than a fraud detection threshold.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a schematic diagram illustrating an exemplary network for providing a consumer services network, according to an illustrative embodiment of the invention.

FIG. 2 is a flow diagram of a method of providing a consumer services network, according to an illustrative embodiment of the invention.

FIG. 3 is flow diagram of a method of providing a consumer services network, according to an illustrative embodiment of the invention.

FIG. 3A and FIG. 3B are exemplary consumer networks showing potential paths between a source node and a target node, according illustrative embodiments of the invention.

FIG. 4 is flow diagram of a method of providing a consumer services network, according to an illustrative embodiment of the invention.

FIG. 5 is a diagram showing an exemplary consumer services network from an institution node point of view, according to an illustrative embodiment of the invention.

FIG. 6 is a diagram showing an exemplary consumer services network from an institution node point of view, according to an illustrative embodiment of the invention.

### DETAILED DESCRIPTION

Generally, an online consumer services network is provided. Each member of the online consumer services network can be viewed as a node. Each time a member of the online consumer services network performs an online electronic transaction with either an existing member or a new entity, an expected transaction score is determined. The expected transaction score is based on a public trust rating score and a private trust rating score. A link between the members (e.g., nodes) of the electronic transaction is created if the electronic transaction includes at least one new entity.

The links between the members can include a trust rating score. The trust rating score can be based on the expected transaction score and an updated transaction score. The trust rating score can be updated for every transaction or for multiple transactions at once. The links between the members can also include a direction of transaction that is an indicator as to which member of the transaction initiated the transaction.

Before performing an electronic transaction with another member of the online consumer services network, members can request a confidence value for a desired electronic transaction. The confidence value can be determined by finding a best path through the online consumer services network. The confidence value can indicate to the requesting member the likelihood of a good experience with the member of the desired electronic transaction.

An institution member of the online consumer services network can request a determination of target nodes. The determination of target nodes indicates which members of the online consumer services network are good targets for the institution to offer services too. The online consumer services network can be queried to obtain a preliminary list of target nodes. The preliminary list of target nodes includes members of the online consumer services network that subscribe to at least one service of the institution member but not all services of the institution member. The target nodes are then selected from the preliminary list of target nodes.

The selected nodes are nodes that are subscribed to a service provided by the institution via a service provider of the consumer network other than the particular member and a trust rating score and/or a confidence value between the node and the service provider that is less than the trust rating score and/or confidence value, respectively, between the node and the institution, or nodes that have a trust rating score and/or confidence value, respectively, between the node and the institution that is greater than a predetermined threshold.

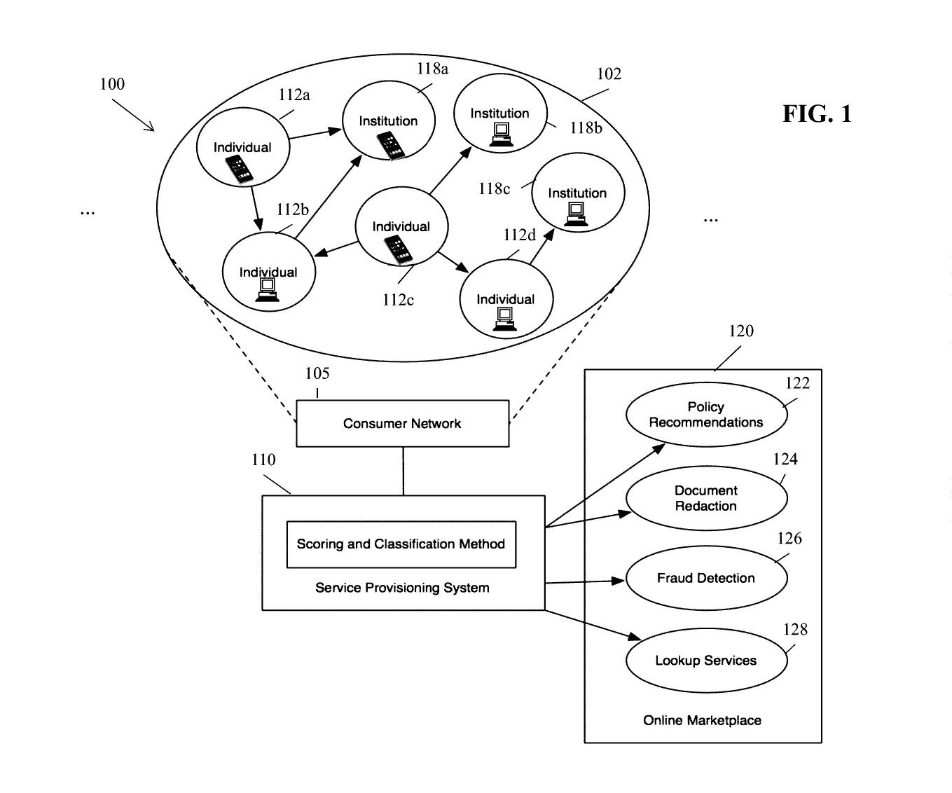

FIG. 1 is a schematic diagram illustrating an exemplary system 100 for providing an online consumer services network, according to an illustrative embodiment of the invention. The system 100 includes members 102 (e.g., nodes) of the online consumer services network, a consumer network module 105, a service provisioning module 110 and an online marketplace module 120. In various embodiments, the consumer network module 105, the service provisioning module 110, and the online marketplace module 120 are on the same server device, separate server devices, or any combination thereof. In various embodiments, the consumer network module, 105, the service provision module 110 and/or the online marketplace module 120 are on the cloud.

The members 102 of the online consumer services network include four consumer members 112a, 112b, 112c, 112d, generally, 110, and three institution members 118a, 118b, 118c, generally 118. The members 102 are in communication with the consumer network module 105. As shown in FIG. 1, the members 102 can communicate with the consumer network module 105 via smart phones, computers, tablets, or any computing device capable of transmitting and receiving messages on the internet. The communication can be wired or wireless.

The consumer network module 105 can include a graph-based database service that can provide storage and manage state. The consumer network module 105 can include a relational database servicer for storage of configuration variables. The consumer network module 105 is in communication with the service provisioning module 110.

The service provisioning module 110 includes a scoring and classification module 117. The service provisioning module 110 can manage consuming incoming transactions, determine trust rating scores, determine confidence values, publish scores and/or handle input queries. The service provisioning module 110 is in communication with an online marketplace module 120.

The online marketplace module 120 includes a policy recommendation module 122, a document redaction module 124, a fraud detection module 126 and a lookup services module 128. The online marketplace module 120 can operate as a client to the service provisioning module 110, host the end-user service interface for the policy recommendation module 122, a document redaction module 124, a fraud detection module 126 and/or a lookup services module 128.

In operation, the members 102 of the online consumer services network communicate with each other. Each member can include other members in their network (e.g., create a link) by manually adding the desired member. For example, consumer member 112a can add consumer member 112b. Members can be included in another member's network when an online electronic transaction is complete between the members. For example, consumer member 112c can purchase services from institution member 118a. Once the purchase is complete, institution member 118a can be automatically added to the consumer member 112c network, creating a link between the members. In some embodiments, the consumer services network can be by an Elo algorithm, as is known in the art of the networking. For example, ELO. A.E. The Rating of Chessplayers, Past and Present (Vol. 3); London; Batsford.

The consumer network module 105 collects and stores information regarding each member of the online consumer services network and the links between the members 102. In some embodiments, the information stored includes member type (consumer or institution), unique identifier, tax identification, and/or name. In some embodiments, for institution members, the information stored includes business types (e.g., mortgage lending or auto insurance). In some embodiments, the information stored includes a default trust rating score, a public trust rating score and/or a private trust rating score.

Each time an online electronic transaction occurs including one member of the members 102, a new member is added to the members 102 (requiring a new link), a new link is created between the existing members 102, or a link is updated between the members 102.

It is assumed that a consumer already has joint ownership, beneficiaries, power of attorney, and other roles assigned on existing financial accounts. New entity nodes are created and added as account holders maintain account roles. If an account role is added, modified, or deleted, changes would be reflected on the consumer network. Historic relationships are maintained in the consumer network until explicitly removed by the consumer. This will ensure that the network can maintain financial relationships beyond the life of an account role designation.

For each online electronic transaction, the consumer network module 105 forwards information regarding the online electronic transaction to the servicing provisioning module 110. The servicing provisioning module 110 forwards information for each online electronic transaction to the scoring and classification module 117. The scoring and classification module 117 determines a trust rating score for each electronic transaction. The scoring and classification module 117 queries the consumer network module 105 for any link or member information necessary to determine the trust rating score. The trust rating score is transmitted to the consumer network module 105 and either an existing link or new link is updated with the trust rating score.

In some embodiments, consumer members can request a confidence value to determine whether to complete an online electronic transaction with a give institution member.

The online consumer services network can provide security and lookup services to the members 102 via the online marketplace module 120. In general, the policy recommendations module 122 determines if individuals of institution members or institution members have a need to know confidential information they request. The document redaction module 124 redacts confidential unnecessary information out of documents that need to be provided. The fraud detection module 126 determines if requests for information are likely fraudulent. The lookup services module 128 can provide various information regarding the network members to a requestor.

i. The Document Redaction Module 124

Consumer members of the online consumer services network can be asked to provide documentation to institution members. In some instances, certain data items on the documentation may not needed by the institution members. A consumer member may not want to provide all of the information on the documentation. For example, for an institution member that has a trust rating score that is below a threshold, the consumer network module 105 can alert the consumer member of the trust rating score and recommend that the consumer member allow the document to be redacted.

For example, assume consumer member 112c requests services from institution member 118b that require the consumer member 112c send documentation (e.g., consumer member 112c request warranty services from institution member 118b and is asked to send a credit card statement showing proof of purchase). In some embodiments, when the consumer member 112c request to provide the document to the institution member 118b, the consumer network module 105 transmits the consumer member 112c information and the institution member 118b information to the service provisioning module 110. The service provisioning module 110 queries the scoring and classification module 117 for a trust rating score and/or an expected transaction score.

If the trust rating score and/or the expected transaction score is below a corresponding predefined threshold, respectively, then the service provisioning module 110 transmits a redaction suggestion to the consumer network module 105. The consumer network module 105 transmits the redaction suggestion to the consumer member 112c. If the consumer member 112c agrees to the redaction, then the document redaction module 124 generates a new document with unnecessary sensitive information redacted (e.g., credit card statement with account number information and other non-relevant purchases redacted).

In some embodiments, the consumer member 112c can directly request redaction of the document required for an online electronic transaction with institution member 118b.

ii. The Policy Recommendation Module 122

The policy recommendation module 122 can provide consumer members of the members 102 (e.g., consumer member 112b) with an indication of whether an institution member of the members (e.g., institution member 118a) requesting confidential information has a real need for the confidential information. In some embodiments, the type of person at the institution member requesting the confidential information can impact whether there is a need to know. The need to know can be based on user defined policies and/or a trust rating score between the consumer member and the institution member.

For example, assume consumer member 112b applies for a mortgage with institution member 118a. A loan officer at the institution member 118a can request that the consumer member 112b submit tax returns and income documents. The loan officer has a need to know such information. In this case, if the policy recommendation module 122 ensures that the trust rating score between the consumer member 112b and the institution member 118a is above a predefined threshold, and that the user defined policy states that a loan officer has a need to know this information, the information is sent to the institution member 118a.

In another scenario, if a receptionist at institution member 118a requests the consumer member 112b submit his tax returns and income documents, the receptionist may not have a need to know this information. In this case, the policy recommendation module 122 determines that the institution member 118a requestor is a receptionist and alerts the consumer member 112b that the receptionist may not have a need to know. If the receptionist is authorized by the loan officer to collect this information, the consumer member 112b can override the policy recommendation module 112 and label the receptionist as an authorized user. If the receptionist is labeled as an authorized user, the trust rating score of the link between the consumer member 112b and the institution member 112c can be increased, if the transaction is successful.

iii. The Fraud Detection Module 126

The fraud detection module 126 can provide consumer members of the members 102 (e.g., consumer member 112b) with an indication of whether an institution member of the members (e.g., institution member 118a) requesting confidential information is likely fraudulent. For example, assume consumer member 112b request a warranty payment from institution member 118a. If institution member 118a requests a pay check stub to complete the request, the check stub has nothing to do with proof of payment for the warranty request, thus the fraud detection module 126 can alert the consumer member 112b that fraud is likely. For example, assume a first member submits a warranty claim to a first institution and a private trust rating score between the first member and the first institution is 1500. If the first institution requests a pay stub, the fraud detection module 126 can indicate to the first member that the request is likely fraudulent. Assuming the same transaction, but the document requested is a sales receipt, then the fraud detection module 126 can indicate to the first member that the request is likely not fraudulent. Assuming the same transaction, but the transaction type is a credit application, then the fraud detection module 126 can indicate to the first member that the request is likely not fraudulent.

In some embodiments, even if an individual of an institution member is not a defined as an authorized user to receive particular confidential information of consumer members, if the trust rating score of the link between the consumer member and an institution member is above a predefined threshold, the policy recommendation module 122 does not generate an alert and allows the confidential information to transmit to the institution member. Continuing with the example shown above in paragraph [0052], assume the first member submits a warranty claim to a first institution, with a private trust rating score of 2000. In this scenario, even if the first institution requests a pay stub from the first member, because the trust rating score is 2000 rather than 1500 as shown above, the fraud detection module 126 can indicate to the first member that the request is likely not fraudulent. In this example, the higher trust rating score overrides the fact that a pay stub is not likely documentation needed for a warranty claim in determining likely fraudulence.

In some embodiments, if an individual of an institution member is defined as an authorized user to receive particular confidential information of consumer members, if the trust rating score of the link between the consumer member and an institution member is below a predefined threshold, the policy recommendation module 122 generates an alert and does not allow the confidential information to transmit to the institution member. Continuing with the examples discussed above in paragraphs [0052] and [0053], assume the first member submits a credit application to a first institution, with a private trust rating score of 1200. In this scenario, if the first institution requests a pay stub from the first member, even though a pay stub is likely needed for a credit application, because the private trust rating score is 1200 rather than 1500 as shown above, the fraud detection module 126 can indicate to the first member that the request is likely fraudulent. In this example, the lower trust rating score overrides the fact that a pay stub is likely documentation needed for a credit application in determining likely fraudulence.

iv. The Lookup Services Module 128

The lookup services module 128 can provide three types of lookup: 1) a consumer member lookup; 2) an institution member lookup; and/or a 3) reverse query.

When a consumer member considers subscribing to a new service, the consumer member can request a determination of the institution member having the highest ranked institution on consumer services network, for a given service category based on a confidence value. For example, suppose consumer member 112a lives in California and has a relative (e.g., consumer member 112b) that lives in New Jersey and visits a New Jersey institution member 118a. The institution member 118a can appear in consumer member 112a consumer services network based on the personal relations with consumer member 112b. However, because consumer member 112b is the only consumer member in consumer member 112a's network, this institution member 118a is not going to get high scores. It is likely that consumer member 112a has other local network members that all visited another local institution member (e.g., institution member 118b), thus the local institution member is likely to rank higher in consumer member 112a's network. Thus, the consumer lookup can provide institution members that are most closely rated and highest performing.

Institution members can request a premium customer list, such that, for example the institution member can offer better services, more promotional offers, and/or premium membership status. Typically, institution members select premium customers by creating a set of business rules that fits the business needs. One difficulty with the business rule approach is that before the rules are set up, the institution can hardly predict how many people fit in the targeted profile. Using the lookup service module 128 institution members can select a top percentile of the customer, sorted by confidence values. In these embodiments, the confidence values can be determined based on expected transaction scores.

Institution members can request a determination for consumer members that are likely to want to subscribe to more of their services (e.g., a request for target nodes). Institution members can offer more than one service and not all consumer members subscribed to one service of the institution member subscribe to all services of the institution member. Determining target nodes can be especially desirable for the institution members because the existing customer base can have higher conversion rate than customers that have no previous affiliation with the institution member.

The reverse query can improve the conversion rate further by selecting and targeting only existing customers (e.g., consumer members) who consider the institution member is the best choice for the service offered. For example, institution member 118a can offer three services, mortgage, car loan, and credit card. Consumer member 112a is an existing mortgage customer of institution member 118a but does not use institution member 118a credit card services. Given that institution member 118a already has consumer member 112a's profile, the reverse query provides the institution a ranking of customer members, such as 112a, relative to the strength of their trust rating score as it compares to the trust rating scores for other institutions also offering credit card services.

In some various embodiments, members of the consumer network (e.g., nodes) can be one or any combination of the following exemplary member types:
Advisor—An advisor can be a financial professional rendering a financial service to a consumer. This individual can be a stockbroker, insurance agents, tax preparer, financial planners, estate planners or banker;
Power of Attorney—A power of attorney can grant authority to a third-party, to act on behalf of an account holder. Types of authority can include trading or trading and withdrawal;
Beneficiary—A beneficiary can be any person or entity an account owner chooses to receive the benefits of a financial account after the account holder dies;
Joint Account Holders—Two or more individuals hold a joint account (e.g., survivorship accounts or convenience accounts);
Account Custodian—A custodian is a party taking fiduciary responsibility for an account (e.g., accounts legally held by a minor or with specific distribution instructions);
Family Relationship—For certain types of retirement account distributions, married account holders, must obtain spousal consent by signing in the presence of a notary public;
Referrals—A referral is commonly attributed to a customer for reward purposes; and
Contributors—Customers can run gift contribution campaigns for college savings accounts or charities.

In some various embodiments, online electronic transaction types can be one or any combination of the following exemplary online electronic transactions between various members as follows:
Money movement—Consumers fund accounts and distribute assets from accounts. The funding source or distribution destination can be an account at another institution;
Loans—E.g., mortgages, auto loans, school loans, and/or personal loans. The funding and servicing organization as well as the lienholder is likely to be financial organizations;
Bill pay services—Bill pay services maintain information about payees. These payees are commonly financial institutions and commercial organizations. Examples include credit card issuers, utilities, property management companies, etc.;
Credit cards—Consumer credit card transaction data include automatic payments and frequently occurring payments that represent an institution in the consumer network. Frequently paid merchants can be considered in the case where financial services are offered. If a consumer frequently shops at a store, and the store offers a line of credit, it can be a candidate node in a consumer network;
Account aggregation services—These services can provide a single view across multiple accounts for consumer convenience. Aggregated accounts can be institution nodes in the network;
Automatic draft—Automatic draft can be managed by the payee as opposed to a banking consumer. The electronic transactions in checking, savings, credit union, or money market accounts can be used to identity institutions;
Automatic deposit—Automatic deposits in consumer financial accounts can be incoming or outgoing. Automatic deposits can be for payroll, pensions, social security, child support, and/or alimony payments. Each of these electronic transactions can represent a unique type of relationship and potential to identity an institution and individual node;
Donations—Donations are made either directly to a service;
Trust and estate services—For trusts, the trustee or beneficiary can be an individual or an institution. Charitable trusts are an example of an institutional beneficiary. For estate planning, an attorney or tax can be involved. Wills, health care proxies, and durable power of attorney represent relationships between nodes in the consumer network that can have both individual and institutional components;
Insurance—Group and individual life insurance policies can be sold both directly and through agents. Both can be treated as institutions in the consumer network;
Tax service—Consumers can use tax services to prepare income tax returns. Tax service commonly includes exchange of financial documents. The tax service provider can be an institution node;
Stock plans—Employers providing equity compensation and the administrator of the plan are institution nodes in the network. A consumer can participate in any number of these plans, based on employment history and/or associated compensation;
Institution sponsoring activities such as 401k or employee benefits—Employers providing retirement and other benefits can also be institutions in the network. Employers can match charitable gifts, contributions to retirement accounts, contributions to health savings accounts, and/or more. The administrator for each of these plans can be also considered an institution node in the network;
Commerce—Institution nodes can include commerce modes, for example, retail stores (e.g., which store has the best ice cream), car services, gym membership (e.g., who is the famous personal trainer), health care provider (e.g., who is the trusted dentist), etc.
Loyalty and payment service accounts—Loyalty programs, such as rewards and cash back accounts can require consumer payment and transaction information to verify offer criteria are met. Having the loyalty and payment service providers included as institution nodes, in the consumer network, allows consumers to have increased control over the information exchange and potentially participate in additional programs with ease.

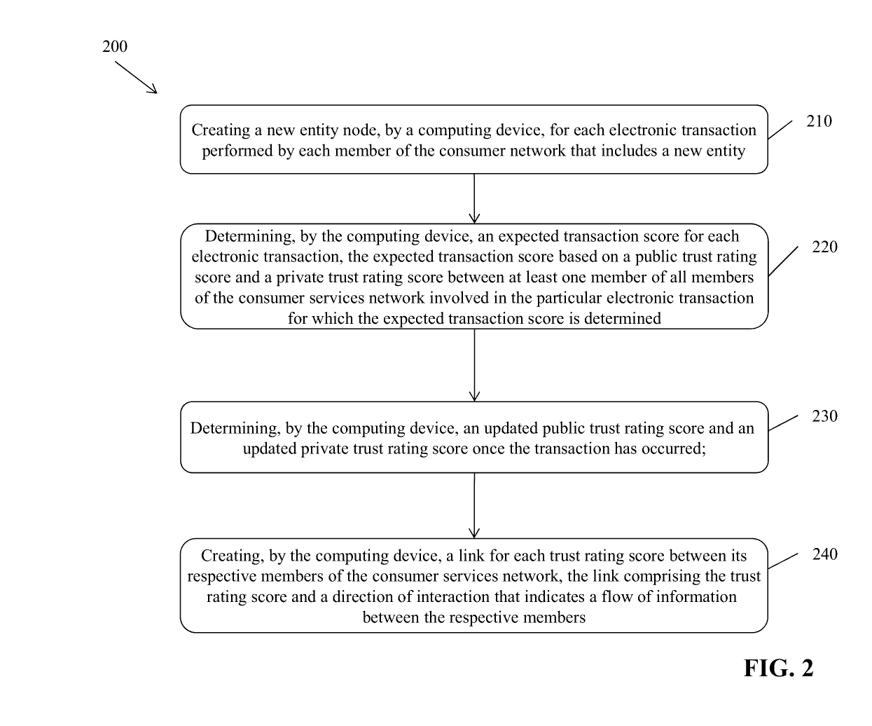

FIG. 2 is a flow diagram 200 of a method providing a consumer services network, according to an illustrative embodiment of the invention.

The method involves creating a new entity node for each electronic transaction performed by each member of the consumer network that includes a new entity (Step 210). For each electronic transaction with a new entity, the new entity information and the relationship between the new entity and its corresponding member is stored. For example, a member (e.g., consumer member 112a, as described above in FIG. 1) can request a new account with a new entity. In this example, the new entity is added to the consumer network, thus creating a new entity node (e.g., institutional member 118a, as described above in FIG. 1). The new account information can be stored within the node.

In some embodiments, for each new entity node that represents an institution, a category list that details the services offered by the institution. For example, for an institution that is a bank, the details of the services offered can be bank accounts, loans, investment vehicles, etc. For an institution that is an online store, the details of the services offered can be same day delivery, discounted bulk delivery, etc.

The method also involves, determining an expected transaction score for each electronic transaction, the expected transaction score is based on a public trust rating score and a private trust rating score between at least one member of all members of the consumer services network involved in the particular electronic transaction for which the transaction score is determined (Step 220).

For each electronic transaction, the electronic transaction is either between an existing member and a new entity or between existing members. As described above, for electronic transactions between a member and a new entity, a new entity node is created. In some embodiments, for each new entity node a default value is can assigned for the public trust rating score and the private trust rating score. For electronic transactions between existing members, a public trust rating score and private trust rating score can be updated.

The public trust rating scores reflect a trust rating over all electronic transactions from related entity nodes. The private trust rating scores represents only directionally the trust level from one node to another node. The electronic transactions that follow a specified edge can be used to maintain the private trust rating score.

In some embodiments, the expected transaction score between the two members of the electronic transaction (e.g., two nodes) can be calculated as shown in EQNs (1), (2) and (3):

$$\begin{matrix}{E}_{pub} = \frac{1}{1 + {10}^{( Rpub \_ his - Rpub \_ curr ) / m 1}} & ( 1 ) \\ {E}_{priv} = \frac{1}{1 + {10}^{( Rpriv \_ his - Rpriv \_ curr ) / m 2}} & ( 2 ) \\ {E}_{total} = \frac{1}{\begin{matrix}w \cdot ( 1 + {10}^{( Rpub \_ his - Rpub \_ curr ) / m 1} ) + ( 1 - w ) \cdot \\ ( 1 + {10}^{( Rpriv \_ his - Rpriv \_ curr ) / m 2} )\end{matrix}} & ( 3 )\end{matrix}$$

where R_{pub}_{_}_{curr} is the current public trust score before the electronic transaction occurs, R_{pub}_{_}ₕᵢₛ the value of R_{pub}_{_}_{curr} before the current public trust score, Rₚᵣᵢᵥ_{_}_{curr} is the current private trust score before the electronic transaction occurs, Rₚᵣᵢᵥ_{_}ₕᵢₛ is value of the previous Rₚᵣᵢᵥ_{_}_{curr} before the current private trust score, w is a weight constant that defines the differential importance between the public trust rating score and the private trust rating score, and m1 and m2 are step control variables that define the magnified unit of expected value changes. In some embodiments, m1 and m2 are defaulted to 400.

In some embodiments, w is based on transaction service type. For example, in the health care industry, private trust rating can be weighted more than the public trust rating score because private trust can be more important in evaluating the trust of a provider. In some embodiments, w is less than 0.5, thus making the private trust rating score dominating over the public trust rating score in determining the expected trust rating score for the electronic.

In some embodiments, the public trust rating score (R_{pub}_{_}_{curr}) is based on current and past quality of transactions between members of the consumer services network. In some embodiments, the private trust rating score (Rₚᵣᵢᵥ_{_}_{curr}) is based on current and past quality of transactions between a specific member of the consumer services network. Each electronic transaction can complete with one of three statuses: 1) successful; 2) unsuccessful; and 3) unknown.

The method also involves, determining an updated public trust rating score and an updated private trust rating score once the transaction has occurred (Step 230).

Once the electronic transaction completes, the public trust rating score (R_{pub}_{_}_{curr}) and the private trust rating score (Rₚᵣᵢᵥ_{_}_{curr}) can be updated for each electronic transaction as shown below in EQNs. (4) and (5):

R′_{pub}_{_}_{curr}=R_{pub}_{_}_{curr}+K₁·(S−E) (4)

R′ₚᵣᵢᵥ_{_}_{curr}=Rₚᵣᵢᵥ_{_}_{curr}+K₂·(S−E) (5)

where R′_{pub}_{_}_{curr} and R′ₚᵣᵢᵥ_{_}_{curr} are the updated public and private trust rating scores, respectively, R_{pub}_{_}_{curr} and Rₚᵣᵢᵥ_{_}_{curr} are the public and private trust rating scores before the electronic transaction, K₁ and K₂ are step control variables, S is the outcome for the electronic transaction, and E is the expected public and private transaction scores as determined in EQNs. 1 and 2 above, respectively.

In some embodiments, a value for S is shown below in Table 1:

TABLE 1
$S = \{ \begin{matrix}1 , & successful transaction \\ 0 , & unsuccessful transaction \\ E + ɛ , & unknown outcome ɛ ≪ 1\end{matrix}$

where E is the expected transaction score and ε is an error value. In various embodiments, the error value is based on assumptions concerning the total population of transaction, some of which are not performed online, and/or assumptions about the distribution of the population.

In some embodiments, whether the electronic transaction is successful or not is based on a type for the electronic transaction. For example, repeated insurance renewals can be treated differently than repeated bill pay transactions, as repeated bill pay transactions can indicate trust between the members less than a repeat insurance renewal. In another example, applications to initiate business transactions can be considered successful, even if the applicant is rejected as part of normal business.

The step control variables K₁ and K₂ can control a linear adjustment proportional to the new rating score when a trust rating score is calculated for a node. A high rate of electronic transaction success can require a smaller K-factor so that the system can prevent score inflation.

In some embodiments, when updating the public trust rating score, if using new coming transactions, the transaction score can be sensitive to the updated public score. In order to avoid the over sensitivity, a transaction history window can be used (e.g. the last 50 or last 100 transactions), such that the public trust rating score is updated with a window of new transactions rather than the newest transaction only. When updating the private trust rating score, every transaction can be considered good to the person himself.

The weight can be selected the network admin. In some embodiments, the weight is selected to correspond to public opinion or personal opinion. For example, to determine which vendor to buy a computer from, public opinion can be more important. Yet for banking services, because the service is more personal, the personal opinions can be more important. For hair stylist, personal opinions weights even more.

In some embodiments, the public trust rating score is updated based on multiple electronic transactions (e.g., batch update) for a given member. In some embodiments, the trust rating score can be more meaningful if outcomes of transactions are processed in larger batches and/or with a higher K-factor for particular transactions types. For example, annual checkup transactions can be less meaningful then medical follow-up and treatment transactions. For example, assume an institution member having five recent electronic transactions, with ε=0.01 and k₁=32. The public trust rating score can be determined as shown below in Table 2.

TABLE 2

| | | | | | |
|---|---|---|---|---|---|
| Transaction | | | | | R′_pub_cur |
| Id | R_pub_his | R_pub_curr | E | S | (New) |

Batch 1

| | | | | | |
|---|---|---|---|---|---|
| 1 | 1500 | 1500 | 0.5 | 1 | 1516 |
| 2 | 1500 | 1516 | 0.523 | 0.533 | 1516.32 |
| 3 | 1500 | 1516.32 | 0.523 | 1 | 1531.57 |
| 4 | 1500 | 1531.57 | 0.545 | 0 | 1514.12 |
| 5 | 1500 | 1514.12 | 0.520 | 0.530 | 1529.47 |

Batch 2

| | | | | | |
|---|---|---|---|---|---|
| 1 | 1514.12 | 1529.47 | 0.522 | 1 | 1544.76 |
| 2 | 1514.12 | 1544.76 | 0.544 | 1 | 1559.36 |
| 3 | 1514.12 | 1559.36 | 0.565 | 0 | 1541.28 |
| 4 | 1514.12 | 1541.28 | 0.539 | 0 | 1556.04 |
| 5 | 1514.12 | 1556.04 | 0.560 | 0.510 | 1554.43 |

The first batch update for each edge, as shown in Table 2, uses a default values for historic and current score, known as R_{pub}_{_}ₕᵢₛ and R_{pub}_{_}_{curr} respectively. After the first batch update, the R′_{pub}_{_}_{curr} is 1529.47. In a subsequent batch update, the R_{pub}_{_}_{curr} and R_{pub}_{_}ₕᵢₛ are assigned to reflect the state resulting from the prior batch. Table 2 also shows the first expected transaction score of the second batch is calculated as 1/(1+10̂((1514.12−1529.47)/400))=0.522. With batch processing, public and expected trust rating scores can be less affected by individual electronic transactions.

The method also involves, creating a link for each trust rating score between its respective members of the consumer services network, the link includes the trust rating score and a direction of transaction that indicates a flow of information between the respective members (Step 240).

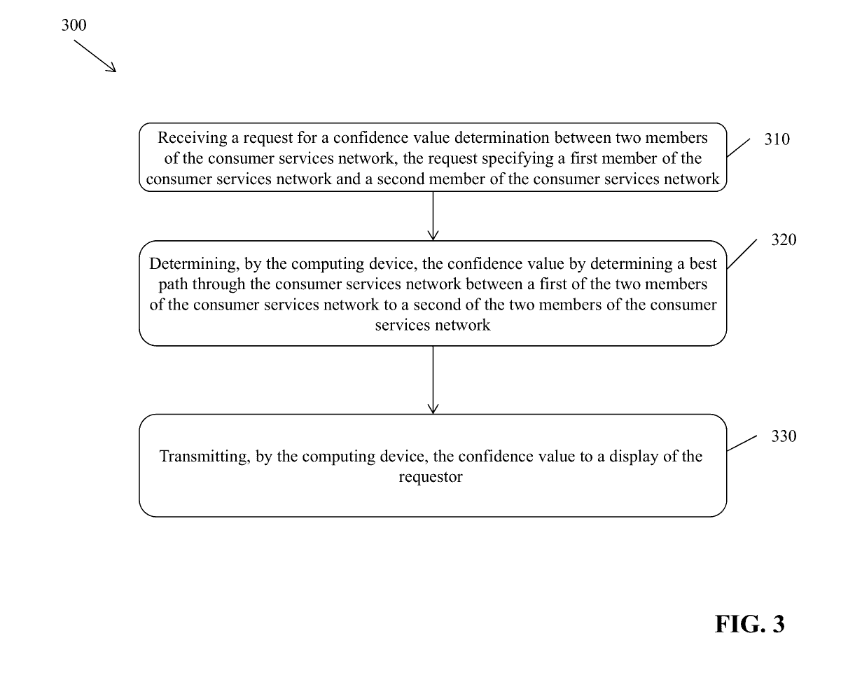

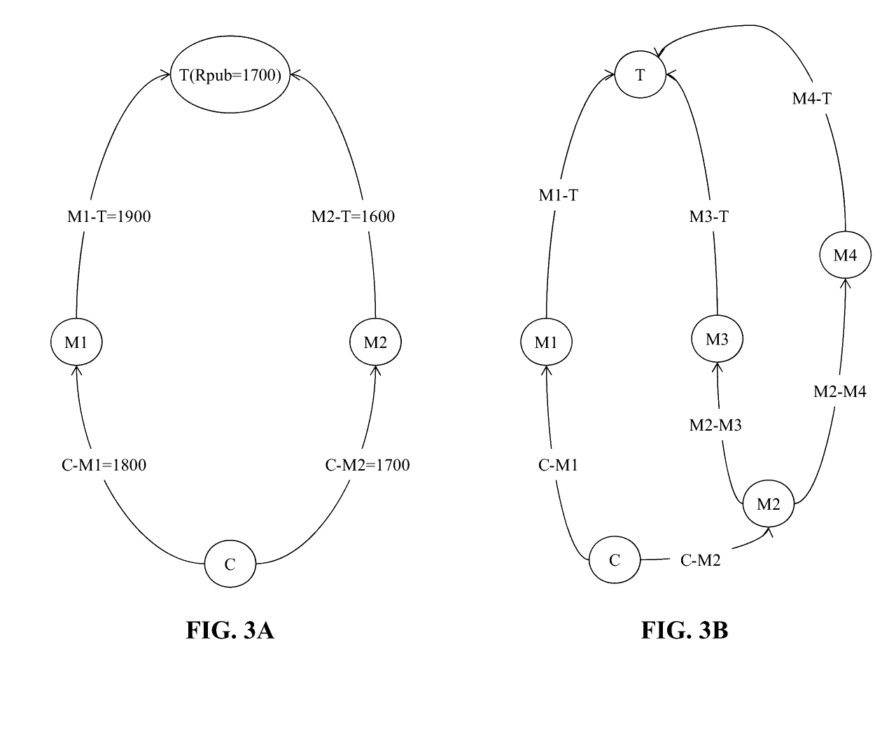

FIG. 3 is a flow diagram 300 for a method for providing a consumer services network, according to an illustrative embodiment of the invention. A member of the consumer services network can request a confidence value.

The method involves receiving a request for a confidence value determination between two members of the consumer services network (e.g., two nodes), the request specifying a first member of the consumer services network (e.g., the consumer member 112a as described above in FIG. 1) and a second member of the consumer services network (e.g., the institution member 118a as described above in FIG. 1). (Step 310). In some embodiments, the first member of the consumer services network is the requestor of the confidence value and the second member of the consumer services network is a target member for the first member to complete an electronic transaction with.

The method also involves determining the confidence value by determining a best path through the consumer services network between a first of the two members of the consumer services network to a second of the two members of the consumer services network (Step 320). The best path can be based on each path's minimum trust rating score, path length, a role consistence in each path, or any combination thereof.

Once a node is created in the consumer services network (e.g., a member is added to the consumer services network) and a first electronic transaction has completed, there can be multiple paths from existing nodes in the consumer network to the new node.

In some embodiments, an edge is built to the second member of the consumer services network by using a default trust rating score. If there is not an intermediate node that has same category of electronic transactions occurring to the target node (e.g., second member), a direct edge can be created from the source node (e.g., first member) to the target node with and initial trust rating score. The initial trust rating score can be determined as shown below in EQN (7):

Rₚᵣᵢᵥ=min(R_{target}_{_{pub}},minR_{target}_{ₚᵣᵢᵥ},Default_{target}) (7)

In some embodiments, there are intermediate nodes that have the same category of electronic transactions as the category of electronic transaction desired between the source and target nodes. For example, assume the source node desires an online electronic transaction with the target node that requires the source node to share personal information with the target node (e.g., the first member wishes to apply for a loan with the second member). If the source node has never had an electronic transaction with the target node, if other members that are connected to the source node have had electronic transactions with the second member, the other member nodes can be used to find the best path to the target node recursively. Once a source node (e.g., a customer) does not have a direct link to the target node (e.g., target service provider), the highest trust score from a set of the most conservative trust scores (e.g., the minimums) from the intermediate nodes can be determined. The trust scores can be determined by determining a best path between the source node and the target node.

In some embodiments, the best path between the source node and the target node can be determined by graph theory as is known in the art, along with the relationship below in EQN. 8.

Let {p₁, p₂, . . . pₙ}, defined as the collection of the potential paths from the source node (S) to target node (T) and Rₚᵢ is the trust score of path pᵢ, then the best path from S to T is:

Path_{best}=Max(Rₚ_{₁},Rₚ_{₂}, . . . ,Rₚ_{₂}) (8)

with m as immediate node connecting with S, the Rₚ_{₁} can be determined as below in EQN. 9:

$$\text{?} = \{ \begin{matrix}Min \text{?} & if m doesn ' t \text{?} ctly connect with T \\ Min \text{?} & if m directly connect with T\end{matrix} \\ \text{?} \text{indicates text missing or illegible when filed} \qquad ( 9 )$$

The best path calculation shown in EQN. 8 follows the exemplary rules: among multiple potential paths, the trust score can be optimistic by selecting the maximum value. (EQN. 8); on each potential path, the trust score determination can be conservative by selecting the minimum value (EQN. 9); and the calculation of trust score for each path can be in recursive model (EQN. 10).

FIG. 3A and FIG. 3B are exemplary consumer networks showing potential paths between a source node (C) and a target node (T). In FIG. 3A, there are two potential paths for connecting C and T:C to M1 to T; and C to M2 to T. In FIG. 3B there are two potential paths for connecting C and T:C to M1 to T: and the complex path of C to M2 to M3 to T or C to M2 to M4 to T.

For FIG. 3A, using EQN. 8 and 9 as shown above, the best path can be determined by determining the trust score of each of the two paths and selecting the path with the maximum trust score, as follows:

Path 1=min(Rₚᵣᵢᵥ(C−M1),min(Rₚᵣᵢᵥ(M1−T),R_{pub}(T)))=min(1800,min(1900,1700))=1700;

Path 2=min(Rpri(C−M2),min(Rpri(M2−T),Rpub(T)))=min(1700,min(1600,1700))=1700; and

the best path is:max(Trust Score Path 1,Trust Score Path 2)=max(1700,1600)=1700.

For FIG. 3B, using EQN. 8 and 9 as shown above, the best path can be determined by determining the trust score of each of the first path, Path 1, and determining the trust score for each path of the complex path, subPath 1 and subPath 2, recursively.

Path 1=min(Rₚᵣᵢᵥ(C−M1),min(Rₚᵣᵢᵥ(M1−T),R_{pub}(T)));

subPath 1=min(Rₚᵣᵢᵥ(M2−M3),min(Rₚᵣᵢᵥ(M3−T),R_{pub}(T)));

subPath 2=min(Rₚᵣᵢᵥ(M2−M4),min(Rₚᵣᵢᵥ(M4−T),R_{pub}(T))); and

the best path is min(Rₚᵣᵢᵥ(max(subPath1,subPath2)).

In some embodiments, the number of intermediate nodes is limited. For example, in some embodiments, if the number of intermediate nodes is greater than 6, then that respective path having greater than six intermediate nodes is defined as not being the best path, and determined to be nonexistent.

The method also involves transmitting the confidence value to a display of the requestor (Step 330).

In some embodiments, the information passing on the highest confidence path is encrypted by the security policy at that level or above.

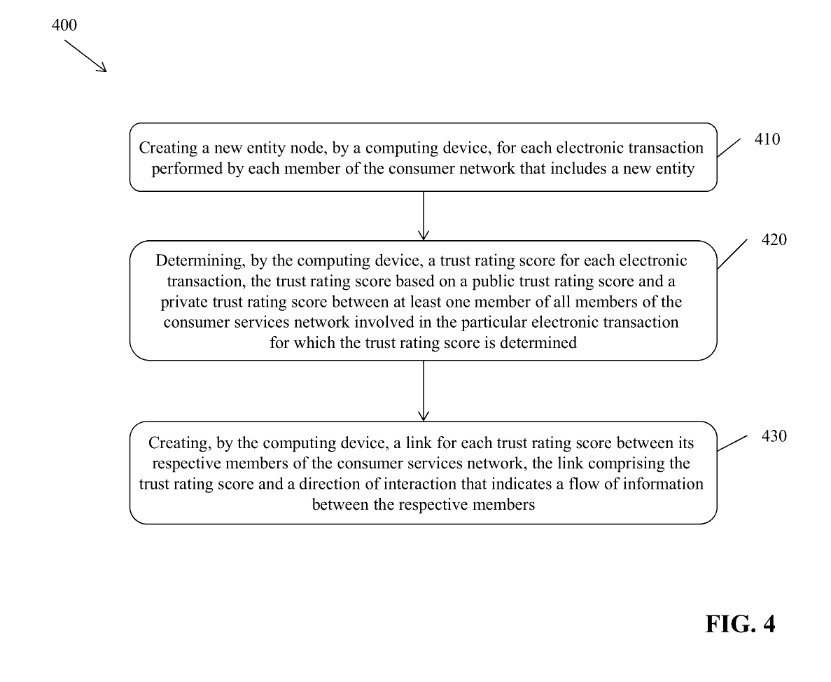

FIG. 4 is a flow diagram 400 for a method for providing a consumer services network, according to an illustrative embodiment of the invention.

An institution member can transmit a request for target nodes. Target nodes can be any member of the consumer services network that is likely to want to subscribe to additional services of the institution member. For example, if a consumer member subscribes to one of four services offered by the institution member and the trust rating score between the consumer member and the institution member is high, then it is more likely that the consumer member will subscribe to additional services of the institution member then a non-member of the network.

The method involves determining a preliminary target node list by adding any member of the consumer network that is subscribed to at least one service of the institution member but not all services of the institution member (Step 410).

The method also involves determining the target nodes by including any member of the consumer network on the preliminary target node list that is subscribed to a service provided by the institution member via a service provider of the consumer network other than the particular member and a trust rating score between the member and the service provider is less than the trust rating score between the member and the particular member, or has a trust rating score between the member and the particular member is greater than a predetermined threshold (Step 420).

The method also involves creating, by the computing device, a link for each trust rating score between its respective members of the consumer services network, the link comprising the trust rating score and a direction of interaction that indicates a flow of information between the respective members (Step 430).

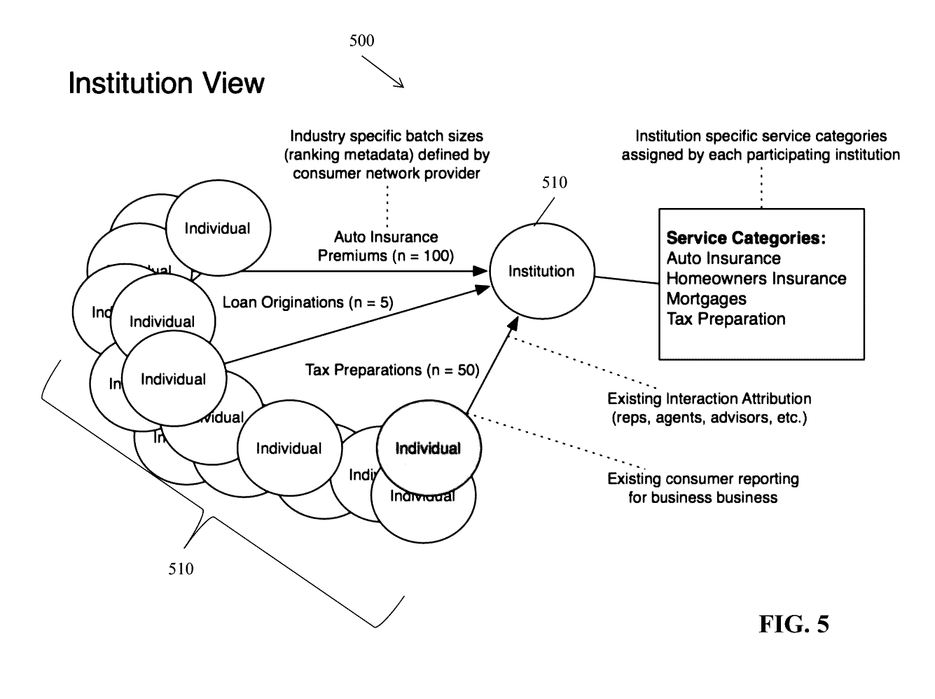

FIG. 5 is a diagram 500 showing an exemplary consumer services network 500 from an institution node point of view, according to an illustrative embodiment of the invention. The consumer services network includes institution node 510 and a plurality of individual nodes 510. The institution node 510 offers online electronic transactions of auto insurance, homeowners insurance, mortgages, and tax preparations. A public trust rating score can be determined for groups of transactions, rather than for a single transaction. A single successful transaction for a particular type of service may not be an indicator that the institution is trustworthy. For example, for a transaction of payment of auto insurance premium contributes less to a trust determination then a loan origination transaction. A public trust rating score can be determined for every 100 auto insurance premium payment transactions and determined for every 5 loan origination transactions. In this manner, it is possible to allow various transaction types to more or less heavily contribute to the trust rating scores.

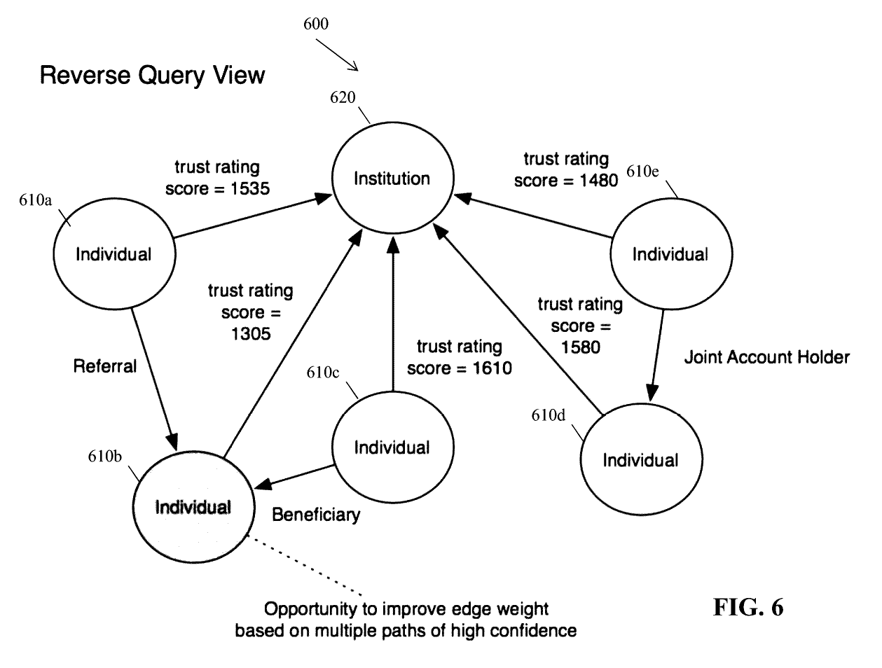

FIG. 6 is a diagram 600 showing an exemplary consumer services network from an institution node point of view, according to an illustrative embodiment of the invention. For various individuals 610a, 610b, 610e, 610d, and 610e, generally, 610 of the consumer services network, an institution 620 can determine which members to target based on the trust rating scores. Multiple paths can connect an individual to an institution, for example, 610b is connected directly to institution 620, by referral of 610a, and as a beneficiary of 610c. The institution 620 can leverage the lookup services of the online marketplace, for example, using the method described in flow diagram 300, to determine confidence values, rank target nodes, and/or identify commercial opportunities.

The above-described computer-implemented methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft®, Internet Explorer® available from Microsoft Corporation, Chrome available from Google, Mozilla® Firefox available from Mozilla Corporation. Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computer-implemented method of providing a consumer services network, the method comprising:
creating a new entity node, by a computing device, for each electronic transaction performed by each member of the consumer network that includes a new entity;
determining, by the computing device, an expected transaction score for each electronic transaction, the expected transaction score based on a public trust rating score and a private trust rating score between at least one member of all members of the consumer services network involved in the particular electronic transaction for which the expected transaction score is determined;
determining, by the computing device, an updated public trust rating score and an updated private trust rating score once the transaction has occurred; and
creating, by the computing device, a link for each transaction score between its respective members of the consumer services network, the link comprising the updated public trust rating score and updated private trust rating score and a direction of transaction that indicates a flow of information between the respective members.

2. The computer-implemented method of claim 1 further comprising:
receiving, by the computing device, a request for a confidence value determination between two members of the consumer services network, the request specifying a first member of the consumer services network and a second member of the consumer services network;
determining, by the computing device, the confidence value by determining a best path through the consumer services network between a first of the two members of the consumer services network to a second of the two members of the consumer services network; and
transmitting, by the computing device, the confidence value to a display of the requestor.

3. The computer-implemented method of claim 1 further comprising:
receiving, by the computing device, a request for target nodes for a particular member of the consumer services network;
determining, by the computing device, a preliminary target node list by adding any member of the consumer network that is subscribed to at least one service of the particular member but not all services of the particular member; and
determining, by the computing device, the target nodes by including any member of the consumer network on the preliminary target node list that:
a) is subscribed to a service provided by the particular member via a service provider of the consumer network other than the particular member and a trust rating score between the member and the service provider is less than a trust rating score between the member and the particular member, or
b) has a trust rating score between the member and the particular member is greater than a predetermined threshold.

4. The computer-implemented method of claim 1 wherein the private trust rating score is based on current and past quality of transaction between each member of the consumer services network.

5. The computer-implemented method of claim 1 wherein the public trust rating score is based on public transactions between each member of the consumer services network.

6. The computer-implemented method of claim 1 wherein the best path is based on each path's minimum trust rating score, path length, a role consistence in each path, or any combination thereof.

7. The computer-implemented method of claim 1 further comprising:
receiving, by the computing device, a request from a first member of the consumer services network for a determination as to whether a second member of the consumer services requires access to information the second member is requesting in relation to a service the second member is proving to the first member;
determining, by the computing device, an expected trust rating score, the expected trust rating score is an estimate of the trust rating score after the electronic transaction between the first member and the second member is complete; and
determining, by the computing device, whether the second member is authorized to receive the information from the first member based on the expected trust rating score.

8. The computer-implemented method of claim 7 wherein the second member is authorized to receive the information if the expected trust rating score is greater than a trust rating threshold.

9. The computer-implemented method of claim 7 further comprising:
filtering, by the computing device, the information if the second member is not authorized to receive the information from the first member.

10. The computer-implemented method of claim 7 further comprising alerting, by the computing device, the first member that the second member is likely a fraudulent user if the difference between the expected trust rating score and the trust rating threshold is greater than a fraud detection threshold.
